(19) United States
(12) Patent Application Publication
(10) Pub. No.: US 2008/0271626 A1
(43) Pub. Date: Nov. 6, 2008

(54) PRINTING PRESS CYLINDER

(75) Inventors: Thomas BOECK, Neusaess (DE); Ralph Klarmann, Neusaess (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 12/114,531

(22) Filed: May 2, 2008

(30) Foreign Application Priority Data
May 5, 2007 (DE) 10 2007 021 158.0

(51) Int. Cl. B41F 13/10

(52) U.S. Cl. 101/375

(57) ABSTRACT

A printing press cylinder having a cylinder base body and a functional layer, which forms an outer surface of the printing press cylinder, is disclosed. The cylinder base body is made of phenolic resin impregnated textile fibers or of hardboard.

This application claims the priority of German Patent Document No. 10 2007 021 158.0, filed May 5, 2007, the disclosure of which is expressly incorporated by reference herein.

### BACKGROUND AND SUMMARY OF THE INVENTION

The invention relates to a printing press cylinder.

In addition to a plate cylinder, which is used to accommodate at least one printing plate, printing couples of printing presses also have a transfer cylinder, which is used to accommodate a transfer plate. Plate cylinders are also designated as engraving cylinders and transfer cylinders are also called blanket cylinders. Impression cylinders cooperate with the transfer cylinders, whereby such an impression cylinder in a printing unit of a web-fed printing press, which comprises several printing couples, can be embodied either as a satellite cylinder or as a transfer cylinder of an adjacent printing couple. Along with plate cylinders, transfer cylinders and impression cylinders, additional cylinders or rollers are used in a printing press, thus, e.g., inking couple rollers, dampening unit rollers and, in the case of web-fed printing presses, web guide rollers. When the term “printing press cylinder” is used in the following, both cylinders as well as rollers are meant.

In the case of web-fed printing presses, there is an increasing trend being recognized to the effect that wider and wider paper webs with an ever greater number of print pages that are positioned side by side are supposed to be printed. Thus, printing presses are already known from practice, whose printing press cylinders are designed in such a way that six print pages can be printed side by side on a printing substrate. Printing press cylinders with such large axial widths tend to deflect as well as to develop increases in the local temperature. This can have a negative impact on the print quality.

Starting herefrom, the present invention is based on the objective of creating a novel printing press cylinder. According to the invention, the cylinder base body is made of phenolic resin impregnated textile fibers or of hardboard.

Within the scope of the present invention, a printing press cylinder is provided, whose cylinder base body is made of phenolic resin impregnated textile fibers or of hardboard. Phenolic resin impregnated textile fibers as well as hardboard gives the printing press cylinder a high level of dimensional stability, but guarantees a considerable reduction in weight, thereby clearly reducing the risk of deflection of the printing press cylinder. The risk of developing increases in local temperatures is also thereby reduced. A cylinder base body made of phenolic resin impregnated textile fibers or of hardboard is corrosion resistant to the greatest possible extent. As a result, it is possible to dispense with special corrosion coatings. A further advantage of a cylinder base body made of phenolic resin impregnated textile fibers or hardboard is that it is considerably more cost-effective as compared with a cylinder base body that is made of glass-fiber reinforced plastic or carbon-fiber reinforced plastic.

According to an advantageous development of the invention, a protective layer is arranged between the cylinder base body made of phenolic resin impregnated textile fibers or of hardboard and the functional layer.

Preferred developments of the invention are yielded from the following description. Without being limited hereto, exemplary embodiments of the invention are explained in greater detail on the basis of the drawings.

### BRIEF DESCRIPTION OF THE DRAWINGS

FIG. 1 is a schematic cross section through an inventive printing press cylinder according to a first exemplary embodiment; and

FIG. 2 is a schematic cross section through an inventive printing press cylinder according to a second exemplary embodiment.

### DETAILED DESCRIPTION OF THE DRAWINGS

The present invention relates to a printing press cylinder of a printing press, in particular of a web-fed printing press.

The inventive printing press cylinder can be a plate cylinder, transfer cylinder or even a satellite cylinder. Furthermore, the inventive printing press cylinder can be an inking couple roller, dampening unit roller or even a web guide roller.

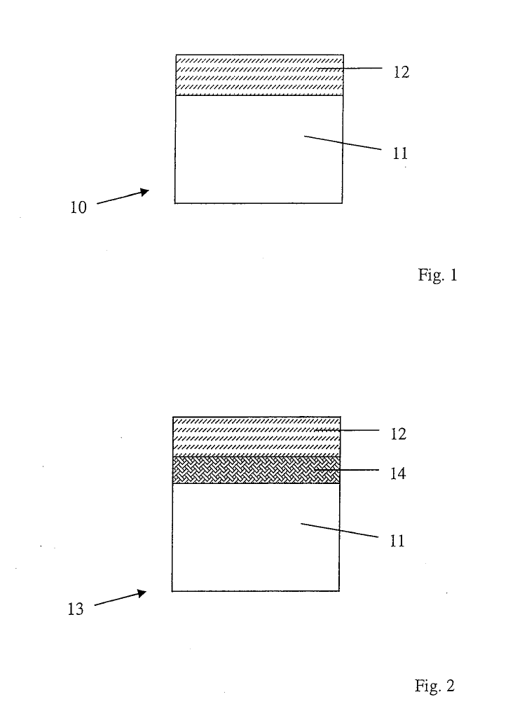

FIG. 1 shows a section of an inventive printing press cylinder 10 in cross section, wherein the printing press cylinder 10 according to FIG. 1 has a cylinder base body 11 and a functional layer 12 applied to the cylinder base body 11. The functional layer 12 forms an outer surface of the printing press cylinder 10.

In terms of the present invention, the cylinder base body 11 is made of phenolic resin impregnated textile fibers. Alternatively, the cylinder base body 11 can also be made of hardboard. A cylinder base body 11 made of phenolic resin impregnated textile fibers or hardboard can be manufactured relatively cost-effectively having high dimensional stability, low weight and high corrosive resistance of the cylinder base body. This makes it possible to reduce the risk of deflection in the case of printing press cylinders that have a relatively large axial length as well as a relatively small diameter and that are therefore relatively thin.

As already mentioned, a functional layer 12 is applied to the cylinder base body 11 made of phenolic resin impregnated textile fibers or hardboard. This functional layer 12 is preferably a functional layer for offset printing. In terms of the functional layer 12, it can be a rubber layer or a plastic layer or a metal layer or a ceramic layer.

In cases where the functional layer 12 is embodied as a rubber layer, the printing press cylinder is preferably designed as an inking couple roller or dampening unit roller.

In cases where the functional layer 12 is embodied as a plastic layer, the printing press cylinder is preferably designed as a film roller or a distributing roller of an inking couple, wherein the plastic layer is then designed as a Rilsan layer.

In cases where the functional layer 12 is embodied as a metal layer, the printing press cylinder can be embodied as a web guide roller or as a distributing roller of a dampening unit or as a plate cylinder of a printing couple or as a transfer cylinder of a printing couple or as a satellite cylinder of a printing unit of a web-fed printing press. The functional layer embodied as a metal layer can either have a nickel base or a chrome base. In the case of a distributing roller of a dampening unit, the functional layer 12 designed as a metal layer preferably has a chrome base. In the case of plate cylinders, transfer cylinders, satellite cylinders or web guide rollers, the functional layer 12 embodied as a metal layer preferably has a nickel base.

In the case of a plate cylinder, transfer cylinder or satellite cylinder, the functional layer 12 can also be embodied as a ceramic layer.

FIG. 2 shows a second exemplary embodiment of an inventive printing press cylinder 13, wherein the printing press cylinder 13 in FIG. 2, in conformity with the exemplary embodiment in FIG. 1, again has a cylinder base body 11 made of phenolic resin impregnated textile fibers or of hardboard as well as an outer functional layer 12. To avoid unnecessary repetitions, reference is made to the statements made above with respect to the cylinder base body 11 as well as to the functional layer 12.

In the exemplary embodiment in FIG. 2, a protective layer 14 is arranged between the cylinder base body 11 and the functional layer 12 of the printing press cylinder 13. The protective layer 14 can, depending on the quality thereof, protect the cylinder base body 11 from mechanical damage or chemical damage.

In cases where the functional layer 12 is designed as a rubber layer, a protective layer 14 is preferably positioned between the cylinder base body 11 and the functional layer 12. This protective layer protects the cylinder base body 11 from mechanical damage, namely in cases where a damaged rubber layer 12 is supposed to be removed from the inventive printing press cylinder in order to replace the rubber layer. Then, on the other hand, when the functional layer 12 is embodied as a plastic layer or as a metal layer or as a ceramic layer, a protective layer 14 positioned between the functional layer 12 and the cylinder base body 11 is preferably designed in such a way that the protective layer protects the cylinder base body 11 from chemical attack.

The inventive printing press cylinder is preferably designed as a 6/1 printing press cylinder or as a 6/2 printing press cylinder or even as a 4/1 printing press cylinder, whereby the first number always indicates the number of print pages that can be printed as viewed in the axial direction and the second number always indicates the number of print pages that can be printed in succession as viewed in the circumferential direction.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing press cylinder having a cylinder base body and a functional layer, which forms an outer surface of the printing press cylinder, wherein the cylinder base body is made of phenolic resin impregnated textile fibers or of hardboard.

2. The printing press cylinder according to claim 1, wherein the functional layer is a rubber layer.

3. The printing press cylinder according to claim 2, wherein the printing press cylinder is embodied as an inking couple roller or a dampening unit roller.

4. The printing press cylinder according to claim 1, wherein the functional layer is a plastic layer.

5. The printing press cylinder according to claim 4, wherein the plastic layer is a Rilsan layer, and wherein the printing press cylinder is embodied as a film roller or a distributing roller of an inking couple.

6. The printing press cylinder according to claim 1, wherein the functional layer is a metal layer.

7. The printing press cylinder according to claim 6, wherein the metal layer has a nickel base, and wherein the printing press cylinder is embodied as a web guide roller.

8. The printing press cylinder according to claim 6, wherein the metal layer has a chrome base, and wherein the printing press cylinder is embodied as a distributing roller of a dampening unit.

9. The printing press cylinder according to claim 6, wherein the printing press cylinder is embodied as a plate cylinder or a transfer cylinder or a satellite cylinder.

10. The printing press cylinder according to claim 1, wherein the functional layer is a ceramic layer.

11. The printing press cylinder according to claim 1, wherein a protective layer is arranged between the cylinder base body and the functional layer.

12. The printing press cylinder according to claim 11, wherein the protective layer protects the cylinder base body from mechanical damage.

13. The printing press cylinder according to claim 11, wherein the protective layer protects the cylinder base body from chemical damage.

14. A printing press cylinder, comprising:
a cylinder base body, wherein the cylinder base body is comprised of phenolic resin impregnated textile fibers or of hardboard; and
a functional layer, wherein the functional layer is an outer surface of the printing press cylinder.

15. The printing press cylinder according to claim 14, wherein the functional layer is disposed on the cylinder base body.

16. The printing press cylinder according to claim 14, further comprising a protective layer disposed between the cylinder base body and the functional layer.

17. The printing press cylinder according to claim 16, wherein the functional layer is a rubber layer and the protective layer is a mechanically protective layer with respect to the cylinder base body.

18. The printing press cylinder according to claim 16, wherein the functional layer is a plastic layer or a metal layer or a ceramic layer and the protective layer is a chemically protective layer with respect to the cylinder base body.

19. The printing press cylinder according to claim 14, wherein the printing press cylinder is a plate cylinder or a transfer cylinder or a satellite cylinder.

20. The printing press cylinder according to claim 14, wherein the printing press cylinder is a 6/1 printing press cylinder or a 6/2 printing press cylinder or a 4/1 printing press cylinder.
